(19) United States
(12) Patent Application Publication
(10) Pub. No.: US 2004/0249595 A1
(43) Pub. Date: Dec. 9, 2004

(54) Method of calibrating a component placement machine, device suitable for carrying out such a method, and calibration component suitable for use in such a method or device

(76) Inventors: Adrianus Johannes Petrus Maria Vermeer, Eindhoven (NL); Dionys Van De Ven, Eindhoven (NL); Robert Cullen, Eindhoven (NL); Maarten Reith, Eindhoven (NL)

Correspondence Address: Philips Electronics North America Corporation, Corporate Patent Counsel, PO Box 3001, Briarcliff Manor, NY, 10510, US

(21) Appl. No.: 10/493,755

(22) PCT Filed: Oct. 24, 2002
(86) PCT No.: PCT/IB02/04488

(30) Foreign Application Priority Data
Nov. 1, 2001 (EP) 01204156.2

(51) Int. Cl. G06F 19/00

(52) U.S. Cl. 702/105

(57) ABSTRACT

Method and device for calibrating a component placement machine (1) which comprises a substrate holder (2) having at least one reference element (4) and a robot (3) having a gripper (5). A calibration component (7) is moved to an expected position of the reference element (4) relative to the robot (3) by means of the gripper (5). The calibration component (7) comprises a first part which (8) can be coupled to the gripper (5) in a removable way, and a second part (9) which is movable relative to said first part (8). The calibration component (7) is aligned relative to the reference element (4) by means of said second part (9), during which alignment said second part (9) moves relative to said first part (8). The actual relative position of the reference element (4) relative to the robot (3) is then determined on the basis of said movement.

The invention relates to a method of calibrating a component placement machine, which machine is provided with a substrate holder comprising at least one reference element and with a robot comprising a gripper.

The invention also relates to a device suitable for carrying out such a method.

The invention further relates to a calibration component suitable for use in such a method and in such a device.

It is of paramount importance during placement of components on a substrate supported by a substrate holder by means of a component placement machine that the components are placed in the desired positions on the substrate. For this purpose, for example, the substrate is positioned over reference elements, comprising pins, of the substrate holder by means of holes present in the substrate. This fixes the position of the substrate with respect to the reference elements. Then a component is picked up by the gripper, and the position of the component relative to the robot comprising the gripper is determined. Now if the relative position of the robot with respect to the reference elements is known, the component can subsequently be placed in the correct position on the substrate. It is accordingly important to ensure that the expected relative position of the robot with respect to the reference element corresponds to the actual relative position.

The methods and devices known per se for the calibration of the component placement machine are comparatively complicated and time-consuming, with the consequence that the mutual positions of the reference element and the robot will be checked comparatively seldom. If the mutual positions, however, are subject to drift owing to wear, temperature fluctuations, etc., this will lead to an incorrect placement of the components on the substrate.

The invention has for its object to provide a method whereby the mutual positions can be ascertained in a comparatively simple manner.

This object is achieved in the method according to the invention in that a calibration component is displaced by the gripper into an expected position of the reference element relative to the robot, which calibration component is provided with a first part that can be detachably coupled to the gripper and with a second part that is displaceable relative to the first part, whereupon the calibration component is aligned with the reference element by its second part, during which the second part is displaceable relative to the first part, and subsequently the actual relative position of the reference element with respect to the robot is determined on the basis of the displacement of the second part relative to the first part.

Such a calibration component can be gripped comparatively easily by the gripper, which is present anyway, and can be displaced into the expected position of the reference element. A subsequent determination of the relative displacement of the second part with respect to the first part, i.e. with respect to the gripper connected to the robot, after the alignment of the second part with the reference element results in a deviation between the expected position of the reference element relative to the robot and the actual relative position of the reference element in a simple manner.

The reference element may here comprise a pin over which the second part is passed. The reference element may alternatively comprise an opening into which the second part is inserted at least partly.

An embodiment of the method according to the invention is characterized in that the displacement of the second part relative to the first part connected to the robot is determined before the actual relative position of the reference element with respect to the robot is determined.

The determination of the displacement of the second part relative to the first part, i.e. the position of the second part relative to the first part, may be achieved, for example, by means of a (laser) measuring device connected to the robot or by means of a measuring device integrated into the first part. This has the advantage that measuring devices already present in the component placement machine can be used.

A further embodiment of the method according to the invention is characterized in that, after the alignment of the second part with the reference element, the second part is fixed with respect to the first part, the second part is disconnected from the reference element, and subsequently the position of the second part relative to the robot is determined by a measuring device.

The fixation of the second part with respect to the first part renders it possible to use a measuring device which forms part of the component placement machine but which is situated at a distance from the reference element. Owing to the fixation of the second part relative to the first part, it is nevertheless possible to ascertain accurately the displacement or changed position of the second part relative to the first part.

The invention also relates to a device for carrying out such a method, which device comprises a component placement machine provided with a substrate holder comprising at least one reference element pin and with a robot comprising a gripper.

According to the invention, said device is characterized in that the device is further provided with a calibration component, which calibration component comprises a first part that can be detachably coupled to the gripper and a second part that is displaceable relative to the first part.

The calibration component renders it possible in a comparatively simple and inexpensive manner to provide the component placement machine with calibration means.

The invention further relates to a calibration component suitable for use in the method or device according to the invention.

According to the invention, the calibration component is for this purpose provided with a first part that can be detachably coupled to a displaceable gripper during operation and with a second part that is displaceable relative to the first part.

Such a calibration component can be manufactured in a comparatively inexpensive and simple manner.

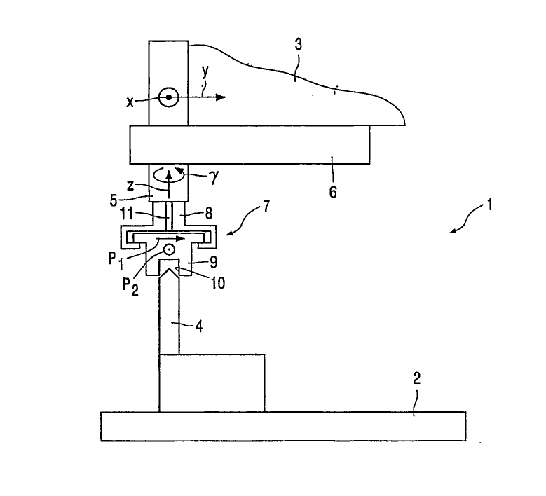

The invention will be explained in more detail below with reference to the drawing, in which FIG. 1 is a side elevation of a component placement machine provided with a calibration component according to the invention.

FIG. 1 shows a component placement machine 1 which is known per se and which is provided with a substrate holder 2 and a robot 3 that is displaceable relative to the substrate holder 2. The substrate holder 2 is provided with a reference element 4 which comprises at least one pin and which is suitable for aligning a substrate (not shown) with the substrate holder 2.

The robot 3 is displaceable in the X- and Y-directions. The robot 3 is provided with a gripper 5 which is displaceable in the Z-direction relative to the robot 3 and which can also rotate in a φ-direction. The robot 3 is further provided with a laser measuring device 6. A component placement machine as described up to this point is known per se.

The component placement machine 1 according to the invention, however, further comprises a calibration component 7 having a first part 8 and a second part 9 which is displaceable relative to the first part in and opposed to the direction indicated by arrow P1 and parallel to the Y-direction, and is displaceable in and opposed to a direction of arrow P2 parallel to the X-direction. The second part 9 is provided with a recess 10.

The component placement machine 1 is calibrated as follows. The first part 8 of the calibration component 7 is gripped by the gripper 5. The robot 3 with the gripper 5 and the calibration component 7 connected thereto is now displaced into an expected position of the reference pin 4. The gripper 5 is moved in downward Z-direction at the area of the reference pin 4 until a recess 10 present in the second part 9 lies at least partly over the reference pin 4, during which the second part 9 will align itself with the reference pin 4. For this purpose, the second part 9 will be capable of displacements in and opposed to the directions indicated by the arrow P1 and indicated by the arrow P2.

Subsequently, the second part 9 is fixed with respect to the first part 8 by a vacuum device which is diagrammatically shown in the form of a vacuum line 11. The robot 3 is then controlled such that the calibration component 7 is moved off the reference pin 4. The laser measuring device 6 then determines the position of the second part 9 relative to the robot 3, the gripper 8 connected thereto, and the first part 7 connected thereto. If the second part 9 was displaced owing to a contact with the reference pin 4 in or opposed to the directions indicated by the arrows P1 and P2, the second part 9 will no longer be centered with respect to the first part 8. Deviations from the centered position of the second part 9 relative to the first part 8 will correspond to the deviations of the expected position of the robot 3 with respect to the reference pin 4 and the actual mutual positions.

Components can now be placed on a substrate by the component placement machine 1. For this purpose, a substrate (not shown) is laid over the reference pins, whereby an accurate positioning of the substrate relative to the substrate holder 2 is obtained. Then the gripper 5 picks up a component whose position relative to the robot 3 is ascertained by means of the measuring device 6. After that the component can be accurately placed in the desired position on the substrate on the basis of this measured position and on the basis of the deviations determined by means of the calibration component.

It is alternatively possible to implement the reference element as a recess in a frame of the component placement machine or as a recess in the reference pin. The second part of the calibration component should be provided with a projection in such a case, for example a peg or pin that can be aligned with the recess of the reference element. The reference element may here be, for example, a tapering hole provided in a strip into which a tapering pin connected to the calibration component can be positioned. The strip may be fastened to a printed circuit board, if so desired.

It is also possible to provide the calibration component on a number of reference elements by means of the robot, so that a yet more accurate mutual relation can be ascertained.

It is also possible to use a mechanical clamping, magnetic clamping, etc., instead of a vacuum device.

If the substrate holder is displaced through the component placement machine 1 by means of a number of indexing movements, it is also possible to determine the position of the substrate holder relative to the robot by means of the method and device according to the invention after each indexing step. Differences between the expected step size and the actual step size can thus be determined in a comparatively simple manner.

1. A method of calibrating a component placement machine, which machine is provided with a substrate holder comprising at least one reference element and with a robot comprising a gripper, characterized in that a calibration component is displaced by the gripper into an expected position of the reference element relative to the robot, which calibration component is provided with a first part that can be detachably coupled to the gripper and with a second part that is displaceable relative to the first part, whereupon the calibration component is aligned with the reference element by its second part, during which the second part is displaceable relative to the first part, and subsequently the actual relative position of the reference element with respect to the robot is determined on the basis of the displacement of the second part relative to the first part.

2. A method as claimed in claim 1, characterized in that the displacement of the second part relative to the first part connected to the robot is determined before the actual relative position of the reference element with respect to the robot is determined.

3. A method as claimed in claim 1, characterized in that, after the alignment of the second part with the reference element, the second part is fixed with respect to the first part, the second part is disconnected from the reference element, and subsequently the position of the second part relative to the robot is determined by a measuring device.

4. A device for carrying out such a method, which device comprises a component placement machine provided with a substrate holder comprising at least one reference element pin and with a robot comprising a gripper, characterized in that the device is further provided with a calibration component, which calibration component comprises a first part that can be detachably coupled to the gripper and a second part that is displaceable relative to the first part.

5. A device as claimed in claim 4, characterized in that the calibration component is provided with means for the detachable fixation of the second part relative to the first part.

6. A device as claimed in claim 5, characterized in that said means comprise vacuum fixation means.

7. A device as claimed in claim 4, characterized in that the calibration component is provided with a measuring device for determining the position of the second part relative to the first part.

8. A device as claimed in claim 4, characterized in that the reference element comprises a pin, and the second part comprises a recess that can be positioned over the reference pin.

9. A calibration component suitable for use in the method as claimed in claim 1 and suitable for use in the device as claimed in any one of the preceding claims 4 to 8, characterized in that the calibration component is provided with a first part that can be detachably coupled to a displaceable gripper during operation and with a second part that is displaceable relative to the first part.
